(19) United States
(12) Patent Application Publication
(10) Pub. No.: US 2017/0097658 A1
(43) Pub. Date: Apr. 6, 2017

(54) Smart Mobile Pouch Device

(71) Applicant: Tamar Levi Matthews, Fort Washington, MD (US)

(72) Inventor: Tamar Levi Matthews, Fort Washington, MD (US)

(21) Appl. No.: 15/284,501

(22) Filed: Oct. 3, 2016

Related U.S. Application Data
(60) Provisional application No. 62/236,199, filed on Oct. 2, 2015.

(51) Int. Cl. G06F 1/16; A45F 3/00; G06F 3/041

(52) U.S. Cl. CPC G06F 1/1626; G06F 1/163; G06F 3/0412; G06F 1/1686; G06F 1/1688; A45F 3/005; A45F 2003/003

(57) ABSTRACT

A smart mobile pouch device is a pouch and a carry grip that can be affixed to a user's body for hand-free transportation of small objects. A housing is also connected to the pouch, that contains a digital display screen, a processing unit, and a power source, providing a smart, compact computing device that provides additional benefit to the user, enabling wireless communication, media playing, and other electronic functionalities. Further components include one or more cameras, a speaker, a headphone jack, a USB port, an SD card port, a flashlight, a plurality of LED lights, and a solar panel.

The current application claims a priority to the U.S. Provisional Patent application Ser. No. 62/236,199 filed on Oct. 2, 2015. The current application is filed on Oct. 3, 2016, whereas Oct. 2, 2016 was on a weekend.

### FIELD OF THE INVENTION

The present invention relates generally to carrying objects. More particularly, the present invention is a portable pouch with mobile electronic device capabilities.

### BACKGROUND OF THE INVENTION

People often desire to carry physical objects on their purpose which serve various purposes, such as keys, mobile phones, wallets, identification cards, currency, and other objects. This is often facilitated through pockets that are constructed integral to clothing, or portable receptacles such as bags or purses. It is often desired, however, to move about or perform activities with minimal impediment from carrying objects in a bag or pockets. Furthermore, some types of clothing do not have pockets and thus a user must carry items in their hands, producing inconvenience for various situations or activities. For example, people may wish to be as minimally encumbered during exercise as possible, while still having to retain necessary objects in their possession, such as keys.

It is therefore an objective of the present invention to present a pouch a user may temporarily attach to their person in order to carry small objects. The present invention allows users to securely store objects on their person in a hands free manner when their pockets are full and even when wearing alternative pocket-less clothing such as gym shorts. The inclusion of electronic components additionally provides the convenience and capabilities of an electronic mobile device such as a smartphone.

### BRIEF DESCRIPTION OF THE DRAWINGS

FIG. 1 is a perspective view of the present invention.

FIG. 2 is a front view of the present invention.

FIG. 3 is a top view of the present invention.

FIG. 4 is a schematic diagram for the power source.

FIG. 5 is a schematic diagram for the processing unit.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

The present invention is a pouch that is attachable to a user's body in order to secure small objects on their person in a hands-free manner aside from using clothes pockets or having to carry external containers.

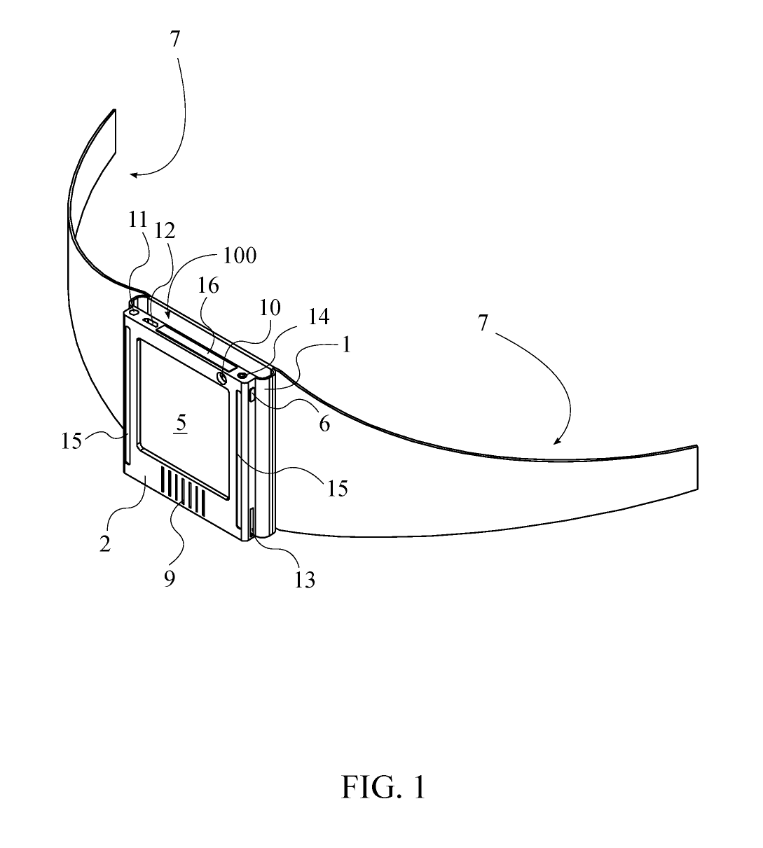

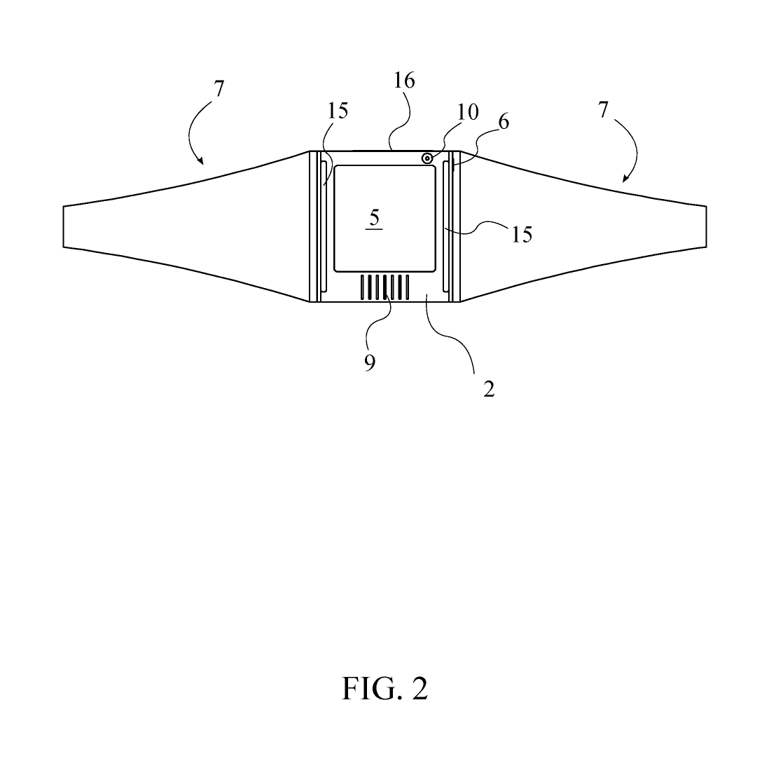

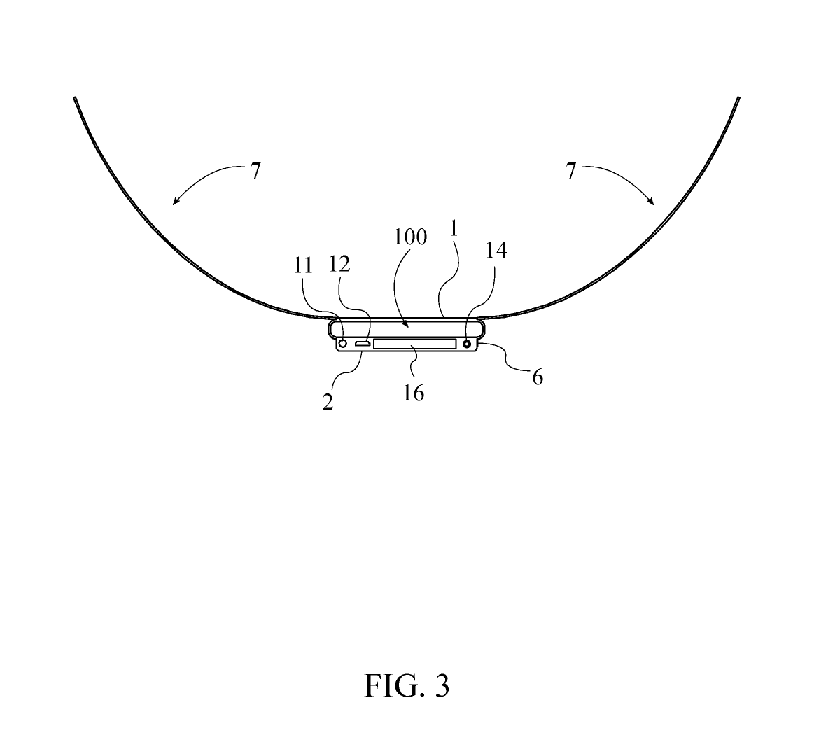

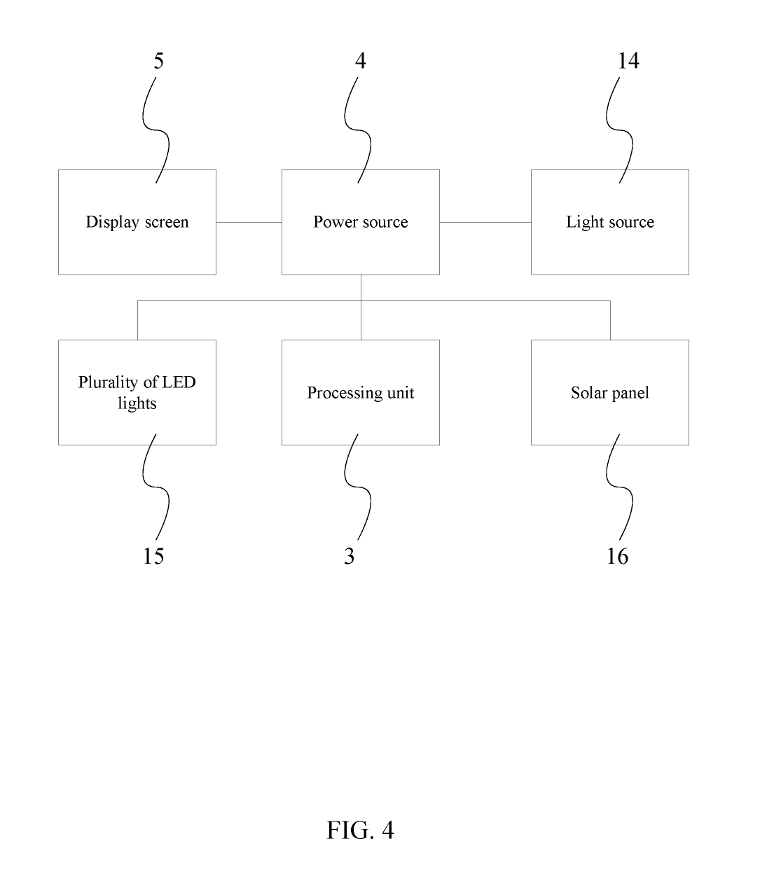

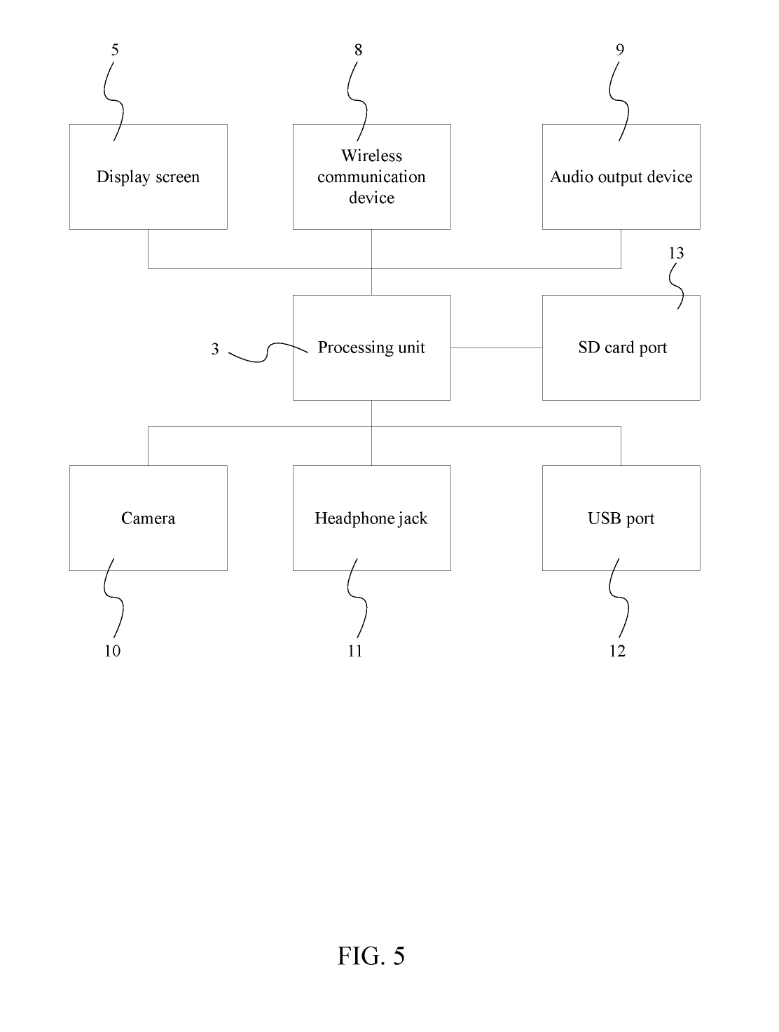

Referring to FIGS. 1-5, the preferred embodiment of the present invention generally comprises a pouch 1, a housing 2, a processing unit 3, a power source 4, and a display screen 5. In the preferred embodiment of the present invention, the pouch 1 is made from a flexible and durable material such as, but not limited to, fabric, rubber, or plastic. However, it should be understood that the pouch 1 may be constructed from any desirable material that facilitates the spirit of the present invention. The pouch 1 is constructed to generally enclose a main cavity 100 into which small objects may be placed. In one embodiment, the pouch 1 has an opening at a top end of the pouch 1. In one embodiment, the pouch 1 further comprises a flap that can be fastened over the opening, sealing objects within the main cavity 100. In the preferred embodiment, the pouch 1 further comprises an RFID blocking material in the construction of the pouch 1 in order to prevent credit card information from being stolen.

The housing 2 generally contains and protects the electronic components of the present invention. In the preferred embodiment, the housing 2 is constructed from a rigid material such as, but not limited to, rigid plastic such as polyethylene or other types of plastic. The material of the housing 2 should be lightweight but sturdy enough to maintain its integrity through typical wear and tear.

The housing 2 is connected to the pouch 1. In one embodiment, the housing 2 is connected adjacent to one external side of the pouch 1, opposite the main cavity 100. It is contemplated that the housing 2 may be removably connected to the pouch 1 in various embodiments, through means such as hook and loop tape, snaps, clips or other types of fasteners.

In another embodiment, the pouch 1 further comprises a housing receptacle. The housing receptacle is connected adjacent to the main cavity 100, and the housing is removably positioned within the housing receptacle. The housing receptacle may be formed in any useful manner. In one embodiment, the housing receptacle is formed by attaching an extra strip of fabric or other material to the external wall of the pouch 1, which encloses the housing 2 and holds the housing 2 against the side of the pouch 1. The housing receptacle should have an aperture in order to view the display screen 5.

The processing unit 3 may be any electronic component or combination of components necessary or desired to facilitate electronic processing of computer-executable instructions stored on a non-transitory computer-readable medium such as memory. It is contemplated that the processing unit 3 may be a microprocessor, integrated circuit, or combination of integrated circuits or other components that facilitates the aforementioned purpose. In the preferred embodiment of the present invention, the power source 4 is a battery. The battery may be of any type of battery chemistry and should provide sufficient electricity to power the device for a reasonable period of time, such as several hours.

The processing unit 3, the power source 4 and the display screen 5 are positioned within the housing 2. The display screen 5, however, is not completely enclosed by the housing 2 and is exposed through an aperture of the housing 2 for access to view and interact with the display screen 5. In the preferred embodiment of the present invention, the display screen 5 is an input-output device capable of displaying digital images and receiving input through touch. The display screen 5 is electronically connected to the processing unit 3, and the power source 4 is electronically connected to the processing unit 3 and the display screen 5.

The preferred embodiment of the present invention further comprises at least one user interface switch 6. Each user interface switch 6 is a physical switch or button that the user interacts with by pressing or sliding in order to produce input to the device. For example, one of the user interface switches may be a power button. Other user interface switches may perform different tasks. Another type of physical user interface may be a scroll wheel. Each user interface switch 6 is connected to the housing 2 and is electronically connected to the processing unit 3.

The preferred embodiment of the present invention further comprises a carry grip 7. The carry grip 7 is an object that facilitates the attachment of the present invention to a user's body in order to carry small objects within the pouch 1 hands-free. In one embodiment, the carry grip 7 is adjacently connected to the pouch 1 opposite the housing 2. In one embodiment, the carry grip 7 is an elastic band. In another embodiment, the carry grip 7 is a strap. In other embodiments, the carry grip 7 may be a protrusion type grip such as a handle. In the preferred embodiment, however, the carry grip 7 is a flexible band or strap that can be affixed in place around a user's body part such as their arm, wrist, leg, or ankle. In the preferred embodiment, the carry grip 7 is removably attached to the pouch 1, so that the carry grip 7 is interchangeable. The user may select various designs for the carry grip 7 in a fashion similar to watch straps. In the preferred embodiment, the carry grip 7 comprises a first strap half and a second strap half, which can be removably and adjustably attached to each other in order to affix the present invention to the user's arm, leg or other body part.

The preferred embodiment of the present invention further comprises a number of features that enhance the functionality of the digital device of the present invention. More particularly, the preferred embodiment of the present invention further comprises a wireless communication device 8. The wireless communication device 8 may be a Bluetooth chipset, a wi-fi chipset, or another type of chipset that enables the present invention to wirelessly communicate with other similarly enabled electronic devices, such as, but not limited to, smartphones and personal computers.

The preferred embodiment of the present invention further comprises an audio output device 9 such as a speaker. The audio output device 9 is positioned within the housing 2, or on the housing 2, or traversing through the housing 2, or any configuration and placement as desirable. The audio output device 9 is electronically connected to the processing unit 3, and enables the user to play audio files such as music, podcasts, audiobooks, or any other type of audio.

The preferred embodiment of the present invention further comprises a camera 10. The camera 10 is connected to the housing 2 in any appropriate configuration, such as traversing through the housing 2, and is electronically connected to the processing unit 3.

Some embodiments of the present invention may comprise a plurality of cameras. For example, in one embodiment a first camera 10 is positioned on the front face of the device adjacent to the display screen 5, and a second camera 10 is positioned on the back face of the device opposite the first camera 10. In one embodiment, the plurality of cameras are distributed around the housing 2, all being oriented in different directions from each other. This enables the user to capture video of all angles around the device. Each of the plurality of cameras is electronically connected to the processing unit 3. In one embodiment, each of the plurality of cameras is retractable into the housing 2. In one embodiment, each camera 10 has a button that the user may push in order to raise the camera 10 from a stored position into a ready position.

The preferred embodiment of the present invention further comprises a headphone jack 11, a USB port 12, and an SD card port 13. The headphone jack 11, the USB port 12, and the SD card port 13 all traverse into the housing 2, and are electronically connected to the processing unit 3.

The preferred embodiment of the present invention further comprises a light source 14 that is connected to the housing 2 and electrically connected to the power source 4. The light source 14 can be used as a flashlight in case the user finds themselves outside at night and needs illumination. The light source 14 may be any desirable type of light emitting device, but is preferably an LED light. In one embodiment, the light source 14 is connected to the housing 2. In another embodiment, the light source 14 is connected to the pouch 1. In one embodiment, the light source 14 may be removable from the main body of the present invention. One embodiment of the present invention comprises a plurality of LED lights 15 that are distributed around the housing 2, or around the pouch 1, or both, and is electrically connected to the power source 4. The plurality of LED lights 15 can serve to visually identify the user if they choose to walk or run in low light situations.

The preferred embodiment of the present invention further comprises a solar panel 16. The solar panel 16 is connected to the housing 2 and is electrically connected to the power source 4. The solar panel 16 can absorb the sun's rays as a source of energy for generating electricity to aid in powering the electrical components of the present invention.

Although the invention has been explained in relation to its preferred embodiment, it is to be understood that many other possible modifications and variations can be made without departing from the spirit and scope of the invention as hereinafter claimed.

What is claimed is:

1. A smart mobile pouch device comprises:
a pouch;
a housing;
a processing unit;
a power source;
a display screen;
the housing being connected to the pouch;
the processing unit, the power source and the display screen being positioned within the housing, wherein the display screen is exposed through the housing;
the display screen being electronically connected to the processing unit; and
the power source being electrically connected to the processing unit and the display screen.

2. The smart mobile pouch device as claimed in claim 1 comprises:
the housing being removably connected to the pouch.

3. The smart mobile pouch device as claimed in claim 1 comprises:
the pouch comprises a main cavity and a housing receptacle;
the housing receptacle being connected adjacent to the main cavity; and
the housing being removably positioned within the housing receptacle.

4. The smart mobile pouch device as claimed in claim 1 comprises:
the display screen being a touchscreen.

5. The smart mobile pouch device as claimed in claim 1 comprises:
at least one user interface switch;
each user interface switch being connected to the housing; and
each user interface switch being electronically connected to the processing unit.

6. The smart mobile pouch device as claimed in claim 1 comprises:
a carry grip; and
the carry grip being removably attached to the pouch opposite the housing, wherein the carry grip is interchangeable.

7. The smart mobile pouch device as claimed in claim 6 comprises:
the carry grip being an elastic band.

8. The smart mobile pouch device as claimed in claim 6 comprises:
the carry grip being a strap.

9. The smart mobile pouch device as claimed in claim 1 comprises:
a wireless communication device;
the wireless communication device being positioned within the housing; and
the wireless communication device being electronically connected to the processing unit.

10. The smart mobile pouch device as claimed in claim 1 comprises:
an audio output device;
the audio output device being positioned within the housing; and
the audio output device being electronically connected to the processing unit.

11. The smart mobile pouch device as claimed in claim 1 comprises:
a camera;
the camera being connected to the housing; and
the camera being electronically connected to the processing unit.

12. The smart mobile pouch device as claimed in claim 1 comprises:
a plurality of cameras;
the plurality of cameras being distributed around the housing;
the plurality of cameras being oriented in different directions from each other; and
the plurality of cameras being electronically connected to the processing unit.

13. The smart mobile pouch device as claimed in claim 12 comprises:
each of the plurality of cameras being retractable into the housing.

14. The smart mobile pouch device as claimed in claim 1 comprises:
a headphone jack;
the headphone jack traversing into the housing; and
the headphone jack being electronically connected to the processing unit.

15. The smart mobile pouch device as claimed in claim 1 comprises:
a USB port;
the USB port traversing into the housing; and
the USB port being electronically connected to the processing unit.

16. The smart mobile pouch device as claimed in claim 1 comprises:
an SD card port;
the SD card port traversing into the housing; and
the SD card port being electronically connected to the processing unit.

17. The smart mobile pouch device as claimed in claim 1 comprises:
a light source;
the light source being connected to the housing; and
the light source being electrically connected to the power source.

18. The smart mobile pouch device as claimed in claim 1 comprises:
a light source;
the light source being connected to the pouch; and
the light source being electrically connected to the power source.

19. The smart mobile pouch device as claimed in claim 1 comprises:
a plurality of LED lights;
plurality of LED lights being distributed around the housing; and
plurality of LED lights being electrically connected to the power source.

20. The smart mobile pouch device as claimed in claim 1 comprises:
a solar panel;
the solar panel being connected to the housing; and
the solar panel being electrically connected to the power source.
